(19) United States
(12) Patent Application Publication
(10) Pub. No.: US 2012/0270571 A1
(43) Pub. Date: Oct. 25, 2012

(54) ANNOTATING ELECTRONIC DATA WITH GEOGRAPHIC LOCATIONS

(75) Inventors: Alexis S. Biller, Easteligh (GB); Steven A. Vandamme, Strombeek-Bever (BE)

(73) Assignee: INTERNATIONAL BUSINESS MACHINES CORPORATION, Armonk, NY (US)

(21) Appl. No.: 13/090,723

(22) Filed: Apr. 20, 2011

(51) Int. Cl. H04W 4/02; H04W 24/00; H04N 5/225

(52) U.S. Cl. 455/456.6; 348/222.1; 455/556.1; 348/E05.024

(57) ABSTRACT

Embodiments of the present invention provide an approach for annotating electronic data with geographic locations. Specifically, a first geographic location of a device (e.g., a camera, a cellular/smart phone, etc.) can be determined using technology such as GPS technology, a wireless Internet signal, and/or a cellular signal. Then, a motion detector associated with the device (e.g., integrated with the device, carried by a user of the device, etc.) will determine a positional difference of the device from the first geographic location (e.g., by detecting a series of movements of the device from the first geographic location). Based on the first geographic location and the positional difference, a second geographic location will be determined/computed. Thereafter, a set of electronic data available to the device (e.g., on the device's internal memory, on a removable memory card inserted into the device, etc.) can be annotated/tagged with the second geographic location. In one embodiment, the second geographic location may only be annotated to the electronic data that was captured/received at the second geographic location.

### FIELD OF THE INVENTION

The present invention relates to location-based annotation/tagging of electronic data such as images and the like. Specifically, embodiments of the present invention relate to an energy efficient approach for detecting location and tagging corresponding data accordingly.

### BACKGROUND OF THE INVENTION

Adding location information to electronic data, such as digital photos, can be a tedious and time-consuming task. The manual task of annotating photos is often done as part of a post-processing operation. While a Global Positioning Service (GPS) chip may be used to annotate a digital photograph or the like, this feature is only available on premium devices, and can suffer from blocked signals (e.g., in enclosed spaces, urban areas, etc.). In addition, GPS chips are not only expensive, but consume a significant amount of power for each positional annotation. The use of wireless fidelity (Wi-Fi) connectivity can suffer from approximation and repeated reliance on the availability of an external Wi-Fi signal. Such signals are not always available, and a poor signal may contribute to significant power requirements for signal collection and automated location annotation.

### SUMMARY OF THE INVENTION

In general, embodiments of the present invention provide an approach for annotating electronic data with geographic locations. Specifically, a first geographic location of a device (e.g., a camera, a cellular/smart phone, etc.) can be determined using technology such as GPS technology, a wireless Internet signal, and/or a cellular signal. Then, a motion detector associated with the device (e.g., integrated with the device, carried by a user of the device, etc.) will determine a positional difference of the device from the first geographic location (e.g., by detecting a series of movements of the device from the first geographic location). Based on the first geographic location and the positional difference, a second geographic location will be determined/computed. Thereafter, a set of electronic data available to the device (e.g., on the device's internal memory, on a removable memory card inserted into the device, etc.) can be annotated/tagged with the second geographic location. In one embodiment, the second geographic location may only be annotated to the electronic data that was captured/received at the second geographic location.

A first aspect of the present invention provides a method for annotating electronic data with geographic locations, comprising: determining a first geographic location of a device; determining a positional difference of the device from the first geographic location using a motion detector associated with the device; determining a second geographic location of the device based on the first geographic location and the positional difference; and annotating a set of electronic data available to the device with the second geographic location.

A second aspect of the present invention provides a device for annotating electronic data with geographic locations, the device comprising an internal memory medium having instructions to: determine a first geographic location of the device; determine a positional difference of the device from the first geographic location using a motion detector associated with the device; determine a second geographic location of the device based on the first geographic location and the positional difference; and annotate a set of electronic data available to the device with the second geographic location.

A third aspect of the present invention provides a computer program product for annotating electronic data with geographic locations, the computer program product comprising a computer readable storage medium, and program instructions stored on the computer readable storage medium, to: determine a first geographic location of the device; determine a positional difference of the device from the first geographic location using a motion detector associated with the device; determine a second geographic location of the device based on the first geographic location and the positional difference; and annotate a set of electronic data available to the device with the second geographic location.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computerized device according to an embodiment of the present invention.

FIG. 2 depicts geographic location determination and data tagging according to an embodiment of the present invention.

FIG. 3 depicts a method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments of the present invention provide an approach for annotating electronic data with geographic locations. Specifically, a first geographic location of a device (e.g., a camera, a cellular/smart phone, etc.) can be determined using technology such as GPS technology, a wireless Internet signal, and/or a cellular signal. Then, a motion detector associated with the device (e.g., integrated with the device, carried by a user of the device, etc.) will determine a positional difference of the device from the first geographic location (e.g., by detecting a series of movements of the device from the first geographic location). Based on the first geographic location and the positional different, a second geographic location will be determined/computed. Thereafter, a set of electronic data available to the device (e.g., on the device's internal memory, on a removable memory card inserted into the device, etc.) can be annotated/tagged with the second geographic location. In one embodiment, the second geographic location may only be annotated to the electronic data that was captured/received at the second geographic location.

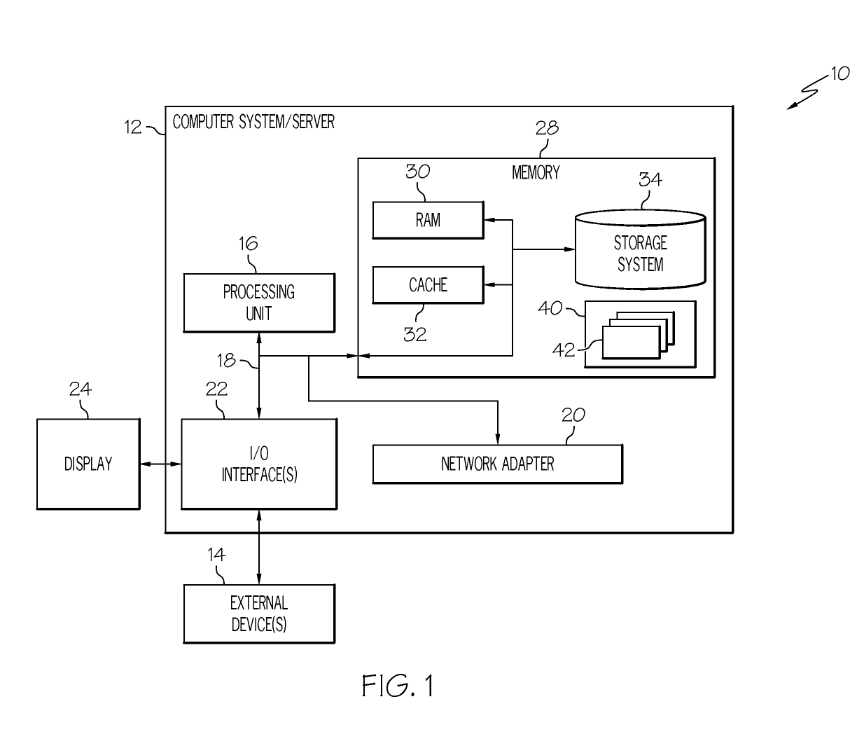

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computerized device (device 12), which is operational with numerous other general purpose or special purpose computing system environments or configurations. Examples of well-known computing systems, environments, and/or configurations that may be suitable for use with device 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Device 12 may be described in the general context of computer system-executable instructions, such as program modules, being executed by a computer system. Generally, program modules may include routines, programs, objects, components, logic, data structures, and so on that perform particular tasks or implement particular abstract data types. Device 12 may be practiced in distributed computing environments where tasks are performed by remote processing devices that are linked through a communications network. In a distributed computing environment, program modules may be located in both local and remote computer system storage media including memory storage devices.

As shown in FIG. 1, device 12 in computing node 10 is shown in the form of a general-purpose computing device. The components of device 12 may include, but are not limited to, one or more processors or processing units 16, a system memory 28, a motion detector 44, a bus 18 that couples various system components including system memory 28 to processor 16. Along these lines, device 12 can be a portable device such as a cellular phone, a camera, etc.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Device 12 typically includes a variety of computer system readable media. Such media may be any available media that is accessible by device 12, and it includes both volatile and non-volatile media, removable and non-removable media.

System memory 28 can include computer system readable media in the form of volatile memory, such as random access memory (RAM) 30 and/or cache memory 32. Device 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention. Motion detector 44 can be any type of motion detector now know or later developed that can detect optional/geographic changes in a physical location of device 12. Along these lines, motion detector 44 can detect and communicate location-based information (e.g., direction of travel, distance, etc.) to processing unit 16 for use by location tagging program/utility 40.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Location tagging program/utility 40, having a set (at least one) of program modules 42, may be stored in memory 28 by way of example, and not limitation, as well as an operating system, one or more application programs, other program modules, and program data. In general, program modules 42 of tagging program/utility 40 perform the function of the present invention as described herein. For example, (among other things) location tagging program/utility 40 will: determine a first geographic location of device 12; determine a positional difference of the device 12 from the first geographic location using a motion detector 44 associated with device 12; determine a second geographic location of device 12 based on the first geographic location and the positional difference; and annotate a set of electronic data available to device 12 with the second geographic location.

Device 12 may also communicate with one or more external devices 14 such as a keyboard, a pointing device, an external motion detector, a memory card/stick, a display 24, etc.; one or more devices that enable a consumer to interact with device 12; and/or any devices (e.g., network card, modem, etc.) that enable device 12 to communicate with one or more other computing devices. Such communication can occur via I/O interfaces 22. Still yet, device 12 can communicate with one or more networks such as a local area network (LAN), a cellular network, a GPS network, a general wide area network (WAN), and/or a public network (e.g., the Internet) via network adapter 20. As depicted, network adapter 20 communicates with the other components of device 12 via bus 18. It should be understood that although not shown, other hardware and/or software components could be used in conjunction with device 12. Examples include, but are not limited to: microcode, device drivers, redundant processing units, external disk drive arrays, RAID systems, tape drives, and data archival storage systems, etc.

It is understood in advance that although a typical embodiment of the present invention will be described in the context of tagging a photograph/image data with locational information, the teachings recited herein can be applied to any type of electronic data. Regardless, as indicated above, device 12 can be equipped with a 3-dimentional (3D) motion detector 44 and a low-power processing capability. Motion detector 44 is used to log locational movement between each photograph and can be used to also log direction of view in 3D space. Each photograph is automatically annotated with the change in position or ‘delta location’. The power requirements for this activity are typically less than that needed to establish a GPS location or undertake Wi-Fi exchange.

For example, in one embodiment, an initial geographic location may be manually defined by the user using a mapping service. Alternatively, the initial geographic location can be determined via a GPS signal, Wi-Fi triangulation, cellular signal triangulation, etc. This approach provides an accurate first reference point from which later locations will be calculated/inferred. The motion away from the initial geographic location (in 3D planes), is then continuously monitored so as to offer the ‘delta location’—that is, the change in position from the previous or first position. As can be seen, after having obtained the first geographic location, the user need not have any dependence on having a GPS, Wi-Fi, and/or cellular.

In another embodiment, the initial geographic location can be unknown as long as the delta location and another defined point can be determined. Specifically, the use of delta locations permits the user to describe a single reference point for the remaining positions to be calculated. Therefore a group of photographs only requires one precise (good) geographic location for all the remaining positions to be calculated from the delta references. Enhanced precision might be permitted by specifying additional reference points. This single position could be offered for any single photo in the sequence (not necessarily the first), or it could be manually defined as part of post-processing. Therefore, the user only needs to specify the location of a single photograph for the remaining locations to be automatically calculated.

The deployment into personnel safety (civilian or military) can be described in a similar manner. The personnel will often have a known good starting point or entry point, but when going underground or underwater, the option to use GPS signals is hampered. The constant logging of movement can be used to infer a location, should the personnel become disorientated. Then they might use the device to retrace their movements or find an alternative route back to a starting point, or simply use the delta-location device to infer the remaining route to a second location. It might also be feasible to dispatch their delta-location track-points to a safety crew that would then be sent to retrieve them.

One concept provided by this approach is the reduction of energy usage to apply geo-location meta data to images or other digital content. This provides enhanced autonomy of the digital/mobile device that is capturing images (or other digital content), easier (possibly faster) process for applying location information to a stream of sequential images, and potentially less data storage required for the delta-location (in comparison with full location information, such as a GPS coordinate).

The difference in geo-location could be obtained using accelerometers in the digital/mobile device that is capturing the images (or other digital content). The use of accelerometers would permit the recording of the movement in x-y-z coordinate space and time. As such, a camera device could be rotated around an axis (e.g. set on a tripod, and rotated to capture the 360 degree view) and only a single full geo-location would need to be recorded. The remainder of the sequence could simply record the (delta) rotation in single plane without any forward/backward movement. This would require less data storage for the geo-location meta-data. It would also only require a GPS location to be obtained once for the full sequence. Alternatively, during post-processing (e.g., download images to a computer and modify digital images) the user/operator could assert a single location for a single photo in the sequence. This same geo-location can be inferred for all other photos in the 360 degree sequence, and can permit the full (or almost complete) path followed to be reconstructed using only one (or more) known full geo-locations while the remaining location information is inferred based on the movement between photo capture points.

An analogy can be drawn from video encoding, where i-frame and p-frame data formats can be considered. Between video frames, there is typically little difference. Therefore, simple image compression can be achieved by just using the difference and amalgamating a series of these changes. The i-frame has complete information (full-frame), whereas the p-frame is the difference/delta in the video frame from the previous frame. In the case of this video encoding, the p-frames will be significantly more numerous than i-frame (full-frame), yet use of too many p-frames is likely to introduce errors which would be obvious to the human eye (e.g., a ratio of 8:1 was used for a period of time, although new video compression techniques are now in use, together with audio compression).

In this analogy, the difference in geo-location is tagged on each photo, and it could be the case that a GPS signal is obtained at individual points in the photo sequence, such that a “known” location can be asserted. It is from these asserted location(s) that the other full geo-locations are inferred, with correction made when another asserted full location becomes known. For real-time inference of geo-location, this approach is quite similar to simple video compression, as described earlier. However, for post-processing (e.g., when the location is being asserted at a later time, perhaps after downloading the images to a computer), an algorithm can be established to provide forward and backward correction to the inferred full geo-locations. This could provide greater accuracy while maintaining the ease-of-use.

One instance of this idea is as an appendix to the image encoding standards, such that the meta-data for the image can include delta-location information. At present, it is permitted to include a geo-location. Such image standards include: RAW, JPEG, JPEG2000 (e.g., for use by mobile phone applications).

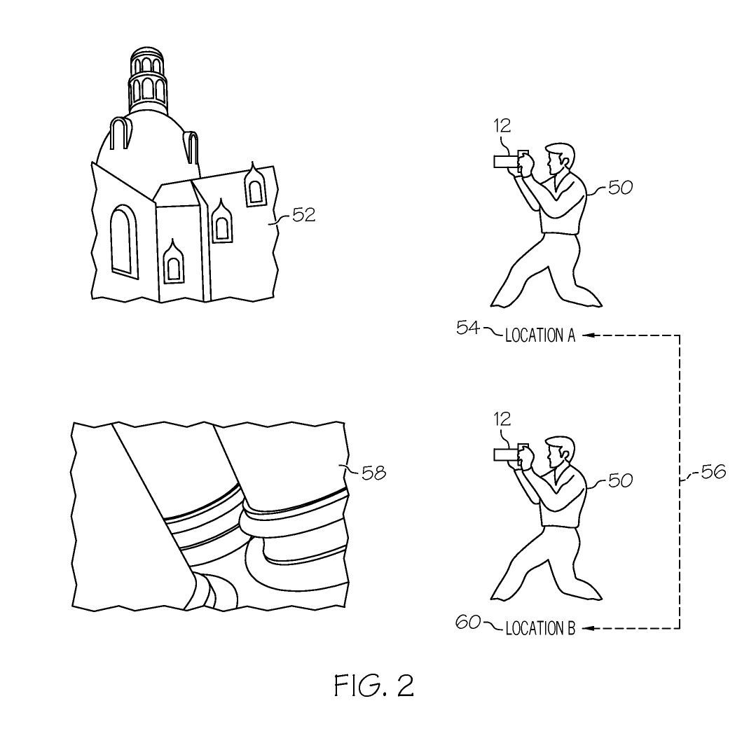

Referring now to FIG. 2, these concepts will be described in greater detail. As shown, a user 50 is taking a photograph of a building 52 in geographic location “A” (location 54) using device 12. As described above, location 54 can be determined (e.g., manually, or automatically via GPS technology, Wi-Fi triangulation, cellular triangulation, etc.). Thus, once taken, the photograph (or electronic data corresponding thereto) of building 52 can be tagged with location 54 by location aging program/utility 40 (FIG. 1). As further shown, user 50 thereafter moves away from location 54 to location “B” (location 60) to photograph structure 58. As user 50 moves away from location 54, motion detector 44 (FIG. 1), in conjunction with location tagging program/utility 40, will determine/calculate the positional difference 56 between location 54 and location 60. In a typical embodiment, motion detector 44 will detect the series of movements (direction and distance) user 50 makes in his/her relocation. Then, location tagging program/utility 40 will determine location 60 based on location 54 and the determined positional difference 56. This allows the electronic data corresponding to the photograph of structure 58 (as stored in the device 12's internal/integrated memory, and/or on a removable memory card inserted into device 12) to be tagged by location tagging program/utility 40 with location 60 (or with meta data corresponding thereto). Thus, even if location 60 is such that a GPS signal, a Wi-Fi signal, cellular signal, etc. cannot be obtained, location 60 can still be determined.

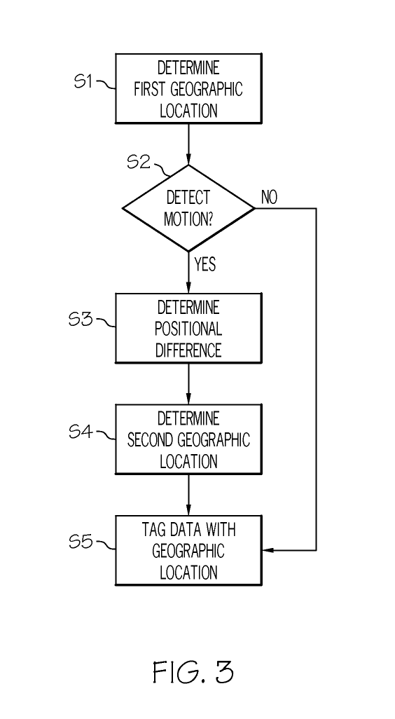

Referring now to FIG. 3, a method flow diagram according to the present invention is shown. As shown, in step S1, a first geographic location of a device is determined. In step S2, it is determined whether motion away from the first geographic location was detected. As indicated above, this is typically accomplished via a motion detector (in conjunction with location tagging program/utility). If the geographic location has not changed, then an initial set of data (captured at the first geographic location) can be tagged with the first geographic location. However, if motion was detected in step S3, the associated positional difference is determined in step S4. Based on the first geographic location (as determined in step S1) and the positional difference, a second geographic location can be determined in step S5. Then, any data captured/gathered at the second geographic location can be tagged accordingly in step S5.

While shown and described herein as a location tagging solution, it is understood that the invention further provides various alternative embodiments. For example, in one embodiment, the invention provides a computer-readable/useable medium that includes computer program code to enable a computer infrastructure to provide location tagging functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide location tagging functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for a location tagging model. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

1. A method for annotating electronic data with geographic locations, comprising:
determining a first geographic location of a device;
determining a positional difference of the device from the first geographic location using a motion detector associated with the device;
determining a second geographic location of the device relative to the first geographic location based on the first geographic location and the positional difference;
annotating a set of electronic data available to the device with the second geographic location and
laying a network of a plurality of sets of electronic data over a geographic location comprising the first and second geographic locations.

2. The method of claim 1, the set of electronic data corresponding to an image captured with the device.

3. The method of claim 1, the first geographic location being determined using at least one of the following: global positioning service technology available to the device, a wireless Internet signal available to the device, or a cellular signal available to the device.

4. The method of claim 1, the determining of a positional difference comprising determining a series of movements of the device away from the first geographic location using the motion detector.

5. The method of claim 1, the set of electronic data being stored on at least one of the following: an internal memory medium integrated with the device, or a removable memory medium inserted into the device.

6. The method of claim 1, the annotating comprising tagging the set of electronic data with meta data corresponding to the second geographic location.

7. The method of claim 1, the device comprising at least one of the following:
a camera, or a phone.

8. A device for annotating electronic data with geographic locations, the device comprising an internal memory medium having instructions to:
determine a first geographic location of the device;
determine a positional difference of the device from the first geographic location using a motion detector associated with the device;
determine a second geographic location of the device relative to the first geographic location based on the first geographic location and the positional difference;
annotate a set of electronic data available to the device with the second geographic location and
lay a network of a plurality of sets of electronic data over a geographic location comprising the first and second geographic locations.

9. The device of claim 8, the set of electronic data corresponding to an image captured with the device.

10. The device of claim 8, the first geographic location being determined using at least one of the following: global positioning service technology available to the device, a wireless Internet signal available to the device, or a cellular signal available to the device.

11. The device of claim 8, the internal memory medium further comprising instructions to determine a series of movements away from the first geographic location using the motion detector.

12. The device of claim 8, the set of electronic data being stored on at least one of the following: the internal memory medium, or a removable memory medium inserted into the device.

13. The device of claim 8, the internal memory medium further comprising instructions to tag the set of electronic data with meta data corresponding to the second geographic location.

14. The device of claim 8, the device comprising at least one of the following:
a camera, or a phone.

15. A computer program product for annotating electronic data with geographic locations, the computer program product comprising a computer readable storage medium, and program instructions stored on the computer readable storage medium, to:
determine a first geographic location of the device;
determine a positional difference of the device from the first geographic location using a motion detector associated with the device;
determine a second geographic location of the device relative to the first geographic location based on the first geographic location and the positional difference;
annotate a set of electronic data available to the device with the second geographic location and
lay a network of a plurality of sets of electronic data over a geographic location comprising the first and second geographic locations.

16. The computer program product of claim 15, the set of electronic data corresponding to an image captured with the device.

17. The computer program product of claim 15, the first geographic location being determined using at least one of the following: global positioning service technology available to the device, a wireless Internet signal available to the device, or a cellular signal available to the device.

18. The computer program product of claim 15, further comprising program instructions stored on the computer readable storage medium to determine a series of movements away from the first geographic location using the motion detector.

19. The computer program product of claim 15, further comprising program instructions stored on the computer readable storage medium to tag the set of electronic data with meta data corresponding to the second geographic location.

20. The computer program product of claim 15, the device comprising at least one of the following: a camera, or a phone.
